(19) United States
(12) Patent Application Publication
(10) Pub. No.: US 2022/0006734 A1
(43) Pub. Date: Jan. 6, 2022

(54) ENCAPSULATED FRAGMENTED PACKET HANDLING

(71) Applicant: VMware, Inc., Palo Alto, CA (US)

(72) Inventors: Yong WANG, San Jose, CA (US); Dexiang WANG, Sunnyvale, CA (US); Xinhua HONG, Campbell, CA (US); Jia YU, San Jose, CA (US)

(73) Assignee: VMware, Inc., Palo Alto, CA (US)

(21) Appl. No.: 16/920,765

(22) Filed: Jul. 6, 2020

(51) Int. Cl. H04L 12/713; H04L 12/717; H04L 29/06; H04L 29/08; H04L 12/46; G06F 9/455

(52) U.S. Cl. CPC H04L 45/586; H04L 45/42; H04L 69/22; H04L 69/164; G06F 2009/45595; H04L 12/4641; H04L 12/4633; G06F 9/45558; H04L 69/326

(57) ABSTRACT

Example methods and computer systems for encapsulated fragmented packet handling. One example may comprise a first computer system detecting an egress packet that requires fragmentation and determining an outer connectionless transport layer value based on content of an inner transport layer header of the egress packet. The first computer system may generate a first encapsulated fragmented packet that includes a first fragment of the inner payload, the inner transport layer header and a first outer header specifying the outer connectionless transport layer value; and a second encapsulated fragmented packet that includes a second fragment of the inner payload and a second outer header specifying the outer connectionless transport layer value. The first encapsulated fragmented packet and the second encapsulated fragmented packet may be forwarded towards a second computer system to cause receive-side processing based on the outer connectionless transport layer value.

### BACKGROUND

Virtualization allows the abstraction and pooling of hardware resources to support virtual machines in a Software-Defined Networking (SDN) environment, such as a Software-Defined Data Center (SDDC). For example, through server virtualization, virtual machines (VMs) running different operating systems may be supported by the same physical machine (e.g., referred to as a “host”). Each VM is generally provisioned with virtual resources to run an operating system and applications. Further, through virtualization for networking service, logical overlay networks may be provisioned, changed, stored, deleted and restored programmatically without having to reconfigure the underlying physical hardware architecture. In practice, when a VM has a large amount of data to send to a destination over a logical network, the data may be transmitted as a series of smaller packets, each including a fragment of the data. However, existing approaches for handling encapsulated fragmented packets may lack efficiency, which may affect the performance of hosts and VMs.

### BRIEF DESCRIPTION OF DRAWINGS

FIG. 1 is a schematic diagram illustrating an example software-defined networking (SDN) environment in which encapsulated fragmented packet handling may be performed;

FIG. 2 is a schematic diagram illustrating an example management plane view of the SDN environment in FIG. 1;

FIG. 3 is a flowchart of an example process for a first computer system to perform encapsulated fragmented packet handling in an SDN environment;

FIG. 4 is a flowchart of an example detailed process for encapsulated fragmented packet handling in an SDN environment;

FIG. 5 is a schematic diagram illustrating a first example of encapsulated fragmented packet handling in an SDN environment;

FIG. 6 is a schematic diagram illustrating a second example of encapsulated fragmented packet handling in an SDN environment; and

FIG. 7 is a schematic diagram illustrating a third example of encapsulated fragmented packet handling in an SDN environment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the drawings, can be arranged, substituted, combined, and designed in a wide variety of different configurations, all of which are explicitly contemplated herein.

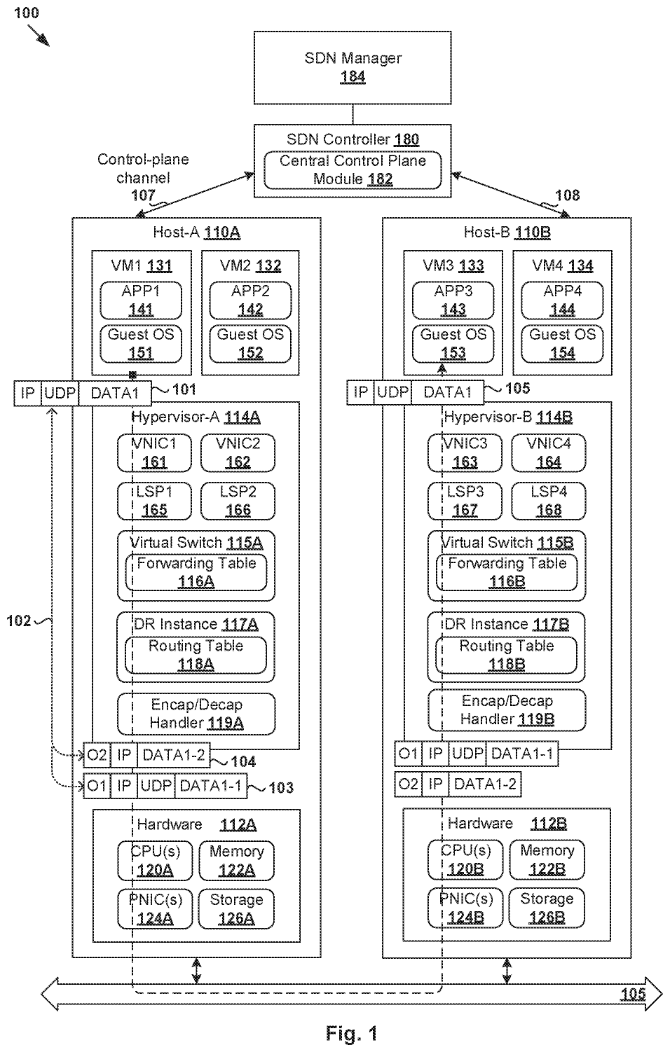

FIG. 1 is a schematic diagram illustrating example software-defined networking (SDN) environment 100 in which encapsulated fragmented packet handling may be performed. It should be understood that, depending on the desired implementation, SDN environment 100 may include additional and/or alternative components than that shown in FIG. 1. Although the terms “first” and “second” are used to describe various elements, these elements should not be limited by these terms. These terms are used to distinguish one element from another. For example, a first element may be referred to as a second element, and vice versa.

SDN environment 100 includes multiple hosts 110A-B that are inter-connected via physical network 105. Each host 110A/110B may include suitable hardware 112A/112B and virtualization software (e.g., hypervisor-A 114A, hypervisor-B 114B) to support virtual machines (VMs). For example, hosts 110A-B may support respective VMs 131-134. Hardware 112A/112B includes suitable physical components, such as central processing unit(s) (CPU(s)) or processor(s) 120A/120B; memory 122A/122B; physical network interface controllers (PNICs) 124A/124B; and storage disk(s) 126A/126B, etc. In practice, SDN environment 100 may include any number of hosts (also known as a “host computers”, “host devices”, “physical servers”, “server systems”, “transport nodes,” etc.), where each host may be supporting tens or hundreds of VMs.

Hypervisor 114A/114B maintains a mapping between underlying hardware 112A/112B and virtual resources allocated to respective VMs. Virtual resources are allocated to respective VMs 131-134 to support a guest operating system (OS; not shown for simplicity) and application(s); see 141-144, 151-154. For example, the virtual resources may include virtual CPU, guest physical memory, virtual disk, virtual network interface controller (VNIC), etc. Hardware resources may be emulated using virtual machine monitors (VMMs). For example in FIG. 1, VNICs 161-164 are virtual network adapters for VMs 131-134, respectively, and are emulated by corresponding VMMs (not shown) instantiated by their respective hypervisor at respective host-A 110A and host-B 110B. The VMMs may be considered as part of respective VMs, or alternatively, separated from the VMs. Although one-to-one relationships are shown, one VM may be associated with multiple VNICs (each VNIC having its own network address).

Although examples of the present disclosure refer to VMs, it should be understood that a “virtual machine” running on a host is merely one example of a “virtualized computing instance” or “workload.” A virtualized computing instance may represent an addressable data compute node (DCN) or isolated user space instance. In practice, any suitable technology may be used to provide isolated user space instances, not just hardware virtualization. Other virtualized computing instances may include containers (e.g., running within a VM or on top of a host operating system without the need for a hypervisor or separate operating system or implemented as an operating system level virtualization), virtual private servers, client computers, etc. Such container technology is available from, among others, Docker, Inc. The VMs may also be complete computational environments, containing virtual equivalents of the hardware and software components of a physical computing system.

The term “hypervisor” may refer generally to a software layer or component that supports the execution of multiple virtualized computing instances, including system-level software in guest VMs that supports namespace containers such as Docker, etc. Hypervisors 114A-B may each implement any suitable virtualization technology, such as VMware ESX® or ESXi™ (available from VMware, Inc.), Kernel-based Virtual Machine (KVM), etc. The term “packet” may refer generally to a group of bits that can be transported together, and may be in another form, such as “frame,” “message,” “segment,” etc. The term “traffic” or “flow” may refer generally to multiple packets. The term “layer-2” may refer generally to a link layer or media access control (MAC) layer; “layer-3” to a network or Internet Protocol (IP) layer; and “layer-4” to a transport layer (e.g., using Transmission Control Protocol (TCP), User Datagram Protocol (UDP), etc.), in the Open System Interconnection (OSI) model, although the concepts described herein may be used with other networking models.

Hypervisor 114A/114B implements virtual switch 115A/115B and logical distributed router (DR) instance 117A/117B to handle egress packets from, and ingress packets to, corresponding VMs. In SDN environment 100, logical switches and logical DRs may be implemented in a distributed manner and can span multiple hosts. For example, logical switches that provide logical layer-2 connectivity (i.e., an overlay network) may be implemented collectively by virtual switches 115A-B and represented internally using forwarding tables 116A-B at respective virtual switches 115A-B. Forwarding tables 116A-B may each include entries that collectively implement the respective logical switches. Further, logical DRs that provide logical layer-3 connectivity may be implemented collectively by DR instances 117A-B and represented internally using routing tables (not shown) at respective DR instances 117A-B. The routing tables may each include entries that collectively implement the respective logical DRs.

Packets may be received from, or sent to, each VM via an associated logical port. For example, logical switch ports 165-168 (labelled “LSP1” to “LSP4”) are associated with respective VMs 131-134. Here, the term “logical port” or “logical switch port” may refer generally to a port on a logical switch to which a virtualized computing instance is connected. A “logical switch” may refer generally to a software-defined networking (SDN) construct that is collectively implemented by virtual switches 115A-B in FIG. 1, whereas a “virtual switch” may refer generally to a software switch or software implementation of a physical switch. In practice, there is usually a one-to-one mapping between a logical port on a logical switch and a virtual port on virtual switch 115A/115B. However, the mapping may change in some scenarios, such as when the logical port is mapped to a different virtual port on a different virtual switch after migration of the corresponding virtualized computing instance (e.g., when the source host and destination host do not have a distributed virtual switch spanning them).

Through virtualization of networking services in SDN environment 100, logical networks (also referred to as overlay networks or logical overlay networks) may be provisioned, changed, stored, deleted and restored programmatically without having to reconfigure the underlying physical hardware architecture. SDN controller 180 and SDN manager 184 are example network management entities in SDN environment 100. One example of an SDN controller is the NSX controller component of VMware NSX® (available from VMware, Inc.) that operates on a central control plane. SDN controller 180 may be a member of a controller cluster (not shown for simplicity) that is configurable using SDN manager 184 operating on a management plane. Network management entity 180/184 may be implemented using physical machine(s), VM(s), or both. To send or receive control information, a local control plane (LCP) agent (not shown) on host 110A/110B may interact with central control plane (CCP) module 182 at SDN controller 180 via control-plane channel 107/108.

A logical overlay network may be formed using any suitable tunneling protocol, such as Virtual eXtensible Local Area Network (VXLAN), Stateless Transport Tunneling (STT), Generic Network Virtualization Encapsulation (GENEVE), etc. For example, VXLAN is a layer-2 overlay scheme on a layer-3 network that uses tunnel encapsulation to extend layer-2 segments across multiple hosts which may reside on different layer 2 physical networks. In the example in FIG. 1, VM1 131 on host-A 110A and VM3 133 on host-B 110B may be connected to the same logical switch and located on the same logical layer-2 segment, such as a segment with VXLAN network identifier (VNI)=6000.

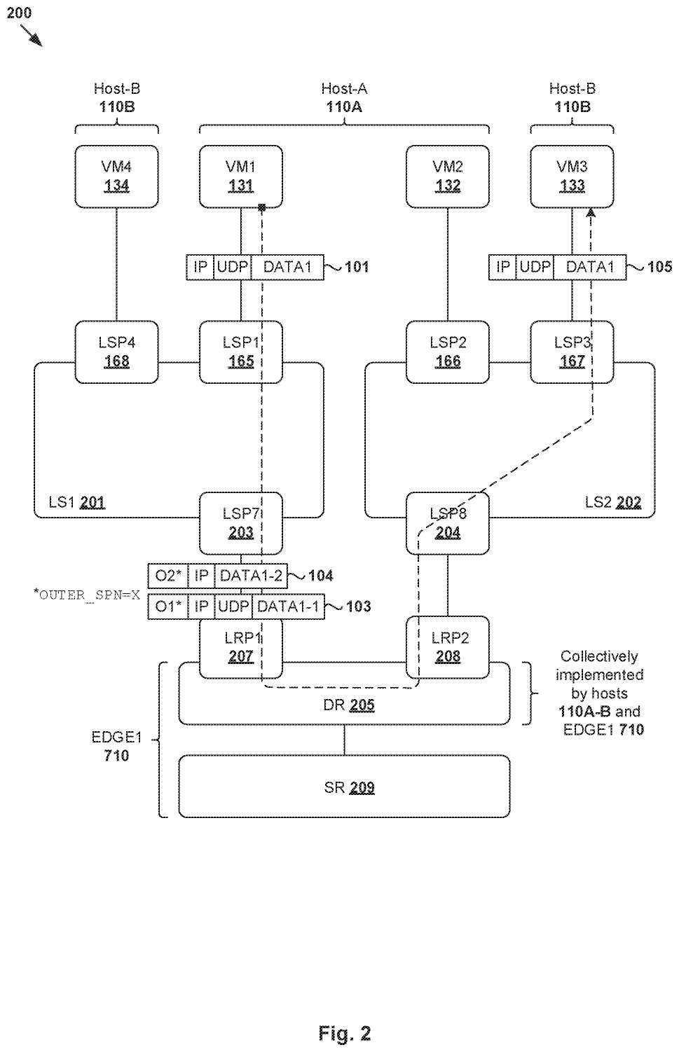

Some example logical overlay networks are shown in FIG. 2, which is a schematic diagram illustrating example management plane view 200 of SDN environment 100 in FIG. 1. Here, VM1 131 and VM4 134 are located on a first logical layer-2 segment associated with virtual network identifier (VNI)=5000 and connected to a first logical switch (see “LS1” 201). VM2 132 and VM3 133 are located on a second logical layer-2 segment associated with VNI=6000 and connected to a second logical switch (see “LS2” 202). With the growth of infrastructure-as-a-service (laaS), logical overlay networks may be deployed to support multiple tenants. In this case, each logical overlay network may be designed to be an abstract representation of a tenant's network in SDN environment 100. Depending on the desired implementation, a multi-tier topology may be used to isolate multiple tenants.

A logical DR (see “DR” 205) connects logical switches 201-202 to facilitate communication among VMs 131-134 on different segments. See also logical switch ports “LSP7” 203 and “LSP8” 204, and logical router ports “LRP1” 207 and “LRP2” 208 connecting DR 205 with logical switches 201-202. Logical switch 201/202 may be implemented collectively by multiple hosts 110A-B, such as using virtual switches 115A-B and represented internally using forwarding tables 116A-B. DR 205 may be implemented collectively by multiple transport nodes, such as using EDGE1 710 and hosts 110A-B. For example, DR 205 may be implemented using DR instances 117A-B and represented internally using routing tables (not shown) at respective hosts 110A-B.

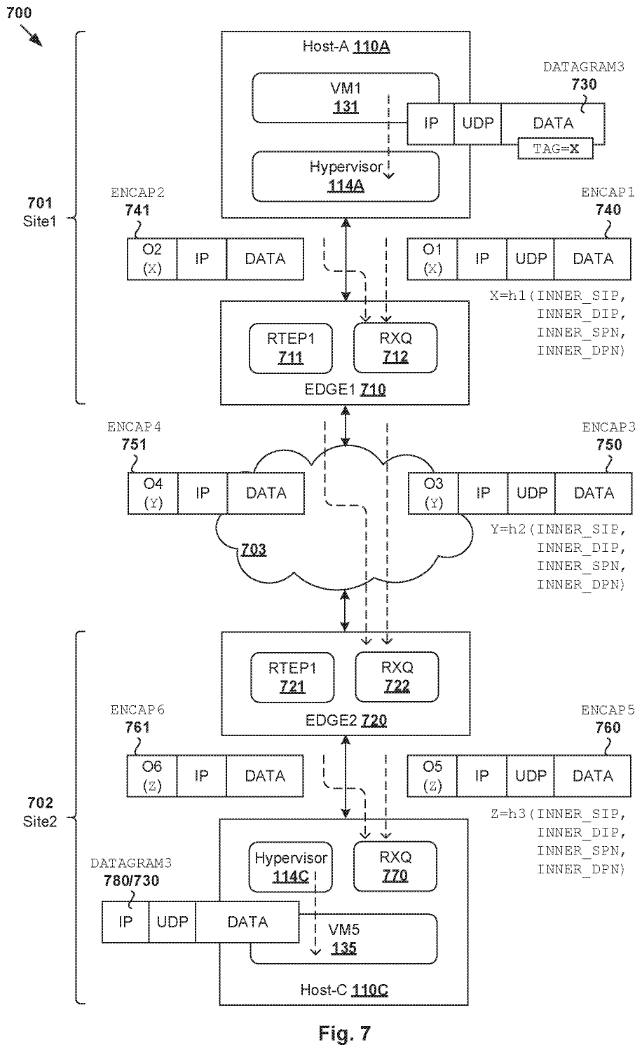

EDGE1 710 may implement one or more logical DRs and logical service routers (SRs), such as DR 205 and SR 209 in FIG. 2. SR 209 may represent a centralized routing component that provides centralized stateful services to VMs 131-134, such as IP address assignment using dynamic host configuration protocol (DHCP), load balancing, network address translation (NAT), etc. In practice, EDGE1 710 may be implemented using VM(s) and/or physical machine (“bare metal machines”) capable of performing functionalities of a switch, router (e.g., logical service router), bridge, gateway, edge appliance, or any combination thereof. In practice, EDGE1 710 may be deployed at the edge of a geographical site to facilitate north-south traffic from a data center to an external network, such as another data center at a different geographical site. Example north-south traffic via EDGE1 710 will be discussed using FIG. 7.

To facilitate communication among VMs 131-134 deployed on various logical overlay networks, hypervisor 114A/114B may implement a virtual tunnel endpoint (VTEP) to encapsulate and decapsulate packets with an outer header (also known as a tunnel header) identifying a logical overlay network. For example, hypervisor-A 114A implements a first VTEP-A associated with (IP address=IP-A, VTEP label=VTEP-A) and hypervisor-B 114B implements a second VTEP-B with (IP-B, VTEP-B). For simplicity, VTEPs are not shown in FIGS. 1-2. Encapsulated packets may be sent via a logical overlay tunnel established between a pair of VTEPs over physical network 105, over which respective hosts 110A-B are in layer-3 connectivity with one another.

In practice, when a source endpoint (e.g., VM1 131 on host-A 110A) has a large amount of data to send to a destination endpoint (e.g., VM3 133 on host-B 110B), the data may be transmitted as a series of fragmented packets that are each encapsulated with an outer header. Through fragmentation, the data may be divided into smaller fragments to satisfy a predetermined maximum transmission unit (MTU) size. However, fragmentation necessitates reassembly at the destination, which increases receive-side processing overhead because all fragments have to be received before reassembly is performed. Further, existing implementation of packet encapsulation (e.g., GENEVE encapsulation) may result in out-of-order delivery of fragmented packets, which affects throughput and performance.

Encapsulated fragmented packet handling

According to examples of the present disclosure, handling of encapsulated fragmented packets may be improved to reduce the overhead relating to receive-side processing. In particular, at a transmit (TX) side, encapsulated fragmented packets generated from the same (unfragmented) large packet may be configured to include the same outer connectionless transport layer value. This way, receive-side processing may be performed based on the outer connectionless transport layer value, such as to facilitate assignment of the encapsulated fragmented packets to the same receive (RX) queue at the destination. This may in turn reduce the likelihood of out-of-order delivery at destination (e.g., due to receive-side processing) to reduce the overhead associated with re-ordering and packet reassembly.

Examples of the present disclosure may be implemented for large packets that are generated according to a connectionless transport layer protocol, such as user datagram protocol (UDP), etc. In general, transport layer delivery of data may be either connection-oriented or connectionless. As used herein, the term “connectionless transport layer” may refer generally to a transport layer that does not require a connection to be established between two endpoints prior to sending packets (also known as “UDP datagrams” for UDP). A “connectionless transport layer” (e.g., UDP) should be contrasted against a connection-oriented transport layer protocol (e.g., TCP). For example, TCP requires a connection establishment (e.g., three-way handshake) between two endpoints prior to packet transmission. TCP is designed to provide a reliable error-free packets in the correct order, whereas UDP does not provide any order of delivery.

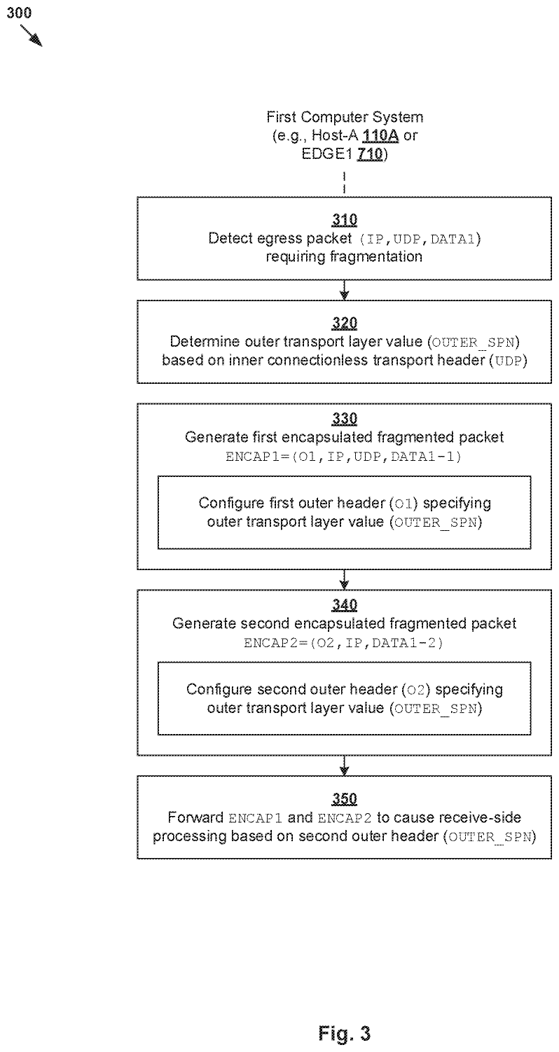

In more detail, FIG. 3 is a flowchart of example process 300 for a first computer system to perform encapsulated fragmented packet handling in SDN environment 100. Example process 300 may include one or more operations, functions, or actions illustrated by one or more blocks, such as 310 to 350. The various blocks may be combined into fewer blocks, divided into additional blocks, and/or eliminated depending on the desired implementation. In the following, various examples will be explained using host-A 110A as an example “first computer system,” host-B 110B as an example “second computer system,” VM1 131 as an example “virtualized computing instance” and UDP as an example “connectionless transport layer.”

At 310 in FIG. 3, host-A 110A may detect an egress packet that requires fragmentation. For example in FIGS. 1-2, the egress packet may include an inner payload (see “DATA1”), an inner network layer header (see “IP”) and an inner transport layer header (see “UDP”) that is generated according to UDP. The egress packet may require fragmentation because its size exceeds a predetermined maximum transmission unit (MTU) size. See 101 in FIG. 1.

At 320 in FIG. 3, host-A 110A may determine an outer connectionless transport layer value based on content of the inner UDP header. Depending on the desired implementation, one example “outer connectionless transport layer value” is an outer UDP source port number (see “OUTER_SPN” in FIG. 3) that is determined based on content of the inner UDP header. One example may involve applying a hash algorithm on any suitable inner tuple information, such as inner UDP source IP address, inner UDP destination IP address, as well as inner UDP source PN and inner UDP destination PN in the inner UDP header, or any combination hereof. See 102 in FIG. 1.

At 330 in FIG. 3, host-A 110A may generate a first encapsulated fragmented packet and a second encapsulated fragmented packet (see 103-104 in FIG. 1. The first encapsulated fragmented packet may be denoted as ENCAP1=(O1, IP, UDP, DATA1-1), where “DATA1-1” represents a first fragment of the inner payload, “IP” an inner IP header, “UDP” an inner UDP header and “O1” a first outer header. The first outer header (O1) is configured to specify the OUTER_SPN. See also 103 in FIG. 1.

At 340 in FIG. 3, host-A 110A may generate a second encapsulated fragmented packet may be denoted as ENCAP2=(O2, IP, DATA1-1), where “DATA1-2” represents a second fragment of the inner payload, “IP” an inner IP header and “O2” a second outer header. According to UDP, note that ENCAP2 usually does not include any inner UDP header. The second outer header (O2) is configured to specify the same OUTER_SPN as the first outer header (O1). See also 104 in FIG. 1.

At 350 in FIG. 3, host-A 110A may forwarding ENCAP1 103 and ENCAP2 104 towards host-B 110B to cause receive-side processing based on the OUTER_SPN value in both the first outer header (O1) and the second outer header (O2). For example, “receive-side processing” may include RX queue assignment at host-B 110B. Based on the same OUTER_SPN, host-B 110B may assign both ENCAP1 103 and ENCAP2 104 to the same RX queue for subsequent reassembly and transmission of an inner packet (see 105 in FIG. 1) towards destination VM3 133.

Examples of the present disclosure should be contrasted against conventional approaches that do not configure the outer header of encapsulated fragmented packets based on the inner UDP header. In this case, the conventional approaches may configure different outer source PNs in encapsulated fragmented packets generated from the same (unfragmented) large UDP packet. The different outer source PNs may in turn result in assignment to different RX queues and out-of-order delivery. Using examples of the present disclosure, the receive-side processing overhead at host-B 110B may be reduced compared to the conventional approaches. By influencing host-B 110B to assign ENCAP1 103 and ENCAP2 104 into the same RX queue, overhead relating to reassembly may be reduced.

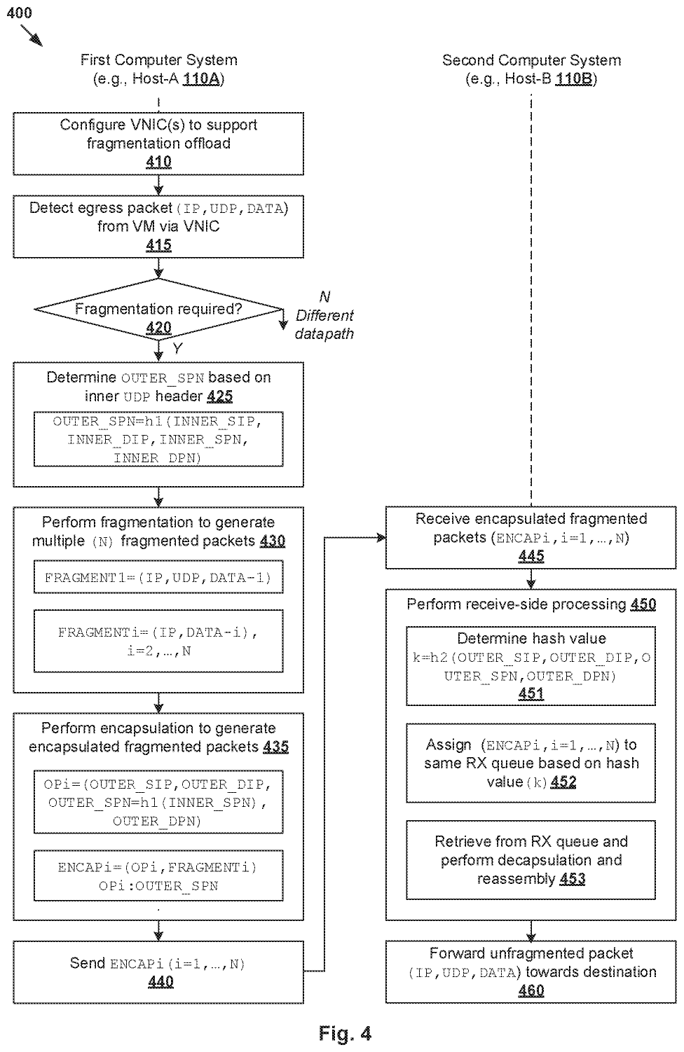

Various examples relating to east-west and north-south traffic will be discussed below using FIGS. 4-7. Throughout the present disclosure, it should be noted that egress packets (e.g., 101 in FIG. 1) and encapsulated fragmented packets (e.g., 103-104 in FIG. 1) may include any suitable header information that is not shown in the drawings for simplicity. For example, egress packet 101 may include an inner layer-2 or Ethernet header that is addressed from a source MAC address to a destination MAC address. In this case, encapsulated fragmented packets 103-104 may each include the Ethernet header between an outer header (O1/O2) and an inner IP header.

East-West Packet Handling

FIG. 4 is a flowchart of example detailed process 400 for encapsulated fragmented packet handling in SDN environment 100. Example process 400 may include one or more operations, functions, or actions illustrated at 410 to 460. The various operations, functions or actions may be combined into fewer blocks, divided into additional blocks, and/or eliminated depending on the desired implementation. In practice, the example in FIG. 4 may be implemented using encapsulation/decapsulation handler 119A/119B supported by hypervisor 114A/114B. Encapsulation/decapsulation handler 119A/119B may also be part of virtual switch 115A/115B.

(a) Transmit-Side Processing

At 410 in FIG. 4, VNIC1 161-164 associated with respective VMs 131-134 may be configured to support UDP fragmentation offload (UFO). Here, UFO may refer generally to a feature that allows a networking stack to offload IP fragmentation functionality to another component. Using VM1 131 as an example, in response to detecting a large UDP datagram that requires fragmentation, a networking stack implemented by guest OS 151 may offload fragmentation of UDP packets to VNIC1 161. In practice, UFO is implemented reduces the processing overhead of the networking stack. Further, according to examples of the present disclosure, UFO may be implemented to retain information associated with the original (unfragmented) UDP datagram, including which fragments are related to each other. Conventionally (without UFO), fragmentation is performed by VM3 133 prior to forwarding various fragments towards encapsulation handler 119A. In this case, since only the first fragment includes an inner UDP header, encapsulation handler 119A would not be able to extract the inner UDP source port number and UDP destination port number from each and each fragment.

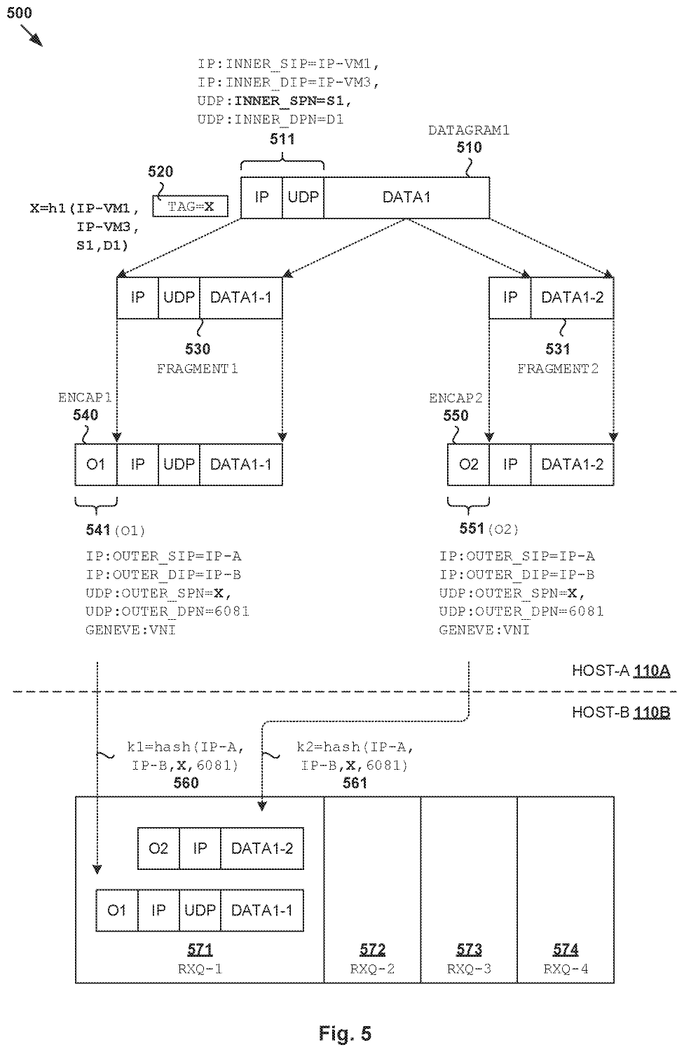

The example in FIG. 4 will be explained using FIG. 5, which is a schematic diagram illustrating first example 500 of encapsulated fragmented packet handling in SDN environment 100. When source VM1 131 on host-A 110A wishes to send data to destination VM3 133 on host-B 110B, VM1 131 (e.g., APP1 141) may generate and send an egress packet via UFO-capable VNIC1 161. For example, the egress packet may be UDP datagram 510 denoted as DATAGRAM1=(IP, UDP, DATA1). Here, UDP datagram 510 may include an inner IP header (see “IP” in FIG. 5), an inner UDP header (see “UDP”) and inner payload (see “DATA1”). In practice, the selection of UDP over TCP is usually application-dependent.

Referring to 511 in FIG. 5, the inner IP header may specify any suitable IP-related information, including source IP address (INNER_SIP)=IP-VM1 and destination IP address (INNER_DIP)=IP-VM3) associated with VM1 131 and VM3 133, respectively. The inner UDP header may specify any suitable UDP-related information, including inner source PN (INNER_SPN)=S1 and inner destination PN (INNER_DPN)=D1. To facilitate subsequent processing by encapsulation handler 119A, egress packet 510 may be tagged with information generated based on the inner IP and UDP headers, such as by applying a hash algorithm to calculate hash value X=h1 (INNER_SIP=IP-VM1, INNER_DIP=IP-VM3, INNER_SPN-S1, INNER_DPN=D3). Any suitable tagging approach may be used, such as a datapath pipeline component configuring a tag or metadata associated with egress packet 510 to specify “TAG=X” (see 520 in FIG. 5).

At 415-420 in FIG. 4, in response to detecting DATAGRAM1 510 from VM1 131 via VNIC1 161, encapsulation handler 119A on host-A 110A may determine that DATAGRAM1 510 requires fragmentation. For example, block 420 may involve comparing the length of egress packet 510 with a predetermined MTU size, which may be set based on an MTU limit supported by PNIC 124A of host-A 110A, etc. In response to determination that the predetermined MTU size is exceeded, UDP fragmentation is determined to be required. Otherwise, if UDP fragmentation is not required, a different processing path may be used.

At 425 in FIG. 4, encapsulation handler 119A may determine an outer source PN (OUTER_SPN) based on the inner UDP header in DATAGRAM1 510. In the example in FIG. 5, block 430 may involve identifying INNER_SPN=S1 from metadata or TAG=X (see 520). If not tagged, the inner UDP header may be parsed to identify the inner tuple information and calculate hash value X=h1 (INNER_SIP=IP−VM1, INNER_DIP=IP-VM3, INNER_SPN=S1, INNER_DPN=D3).

At 430 in FIG. 4, encapsulation handler 119A may perform packet fragmentation to generate multiple fragmented packets from DATAGRAM1 510. For example in FIG. 5, first fragmented packet 530 (see “FRAGMENT1”) includes an inner IP header, an inner UDP header and a first fragment or subset (see “DATA1-1”) of the inner payload of DATAGRAM1 510. Second fragmented packet 531 (see “FRAGMENT2”) includes an inner IP header and a second fragment or subset (see “DATA1-2”). Similar to DATAGRAM1 510, the inner IP header may specify (INNER_SIP=IP-VM1, INNER_DIP=IP-VM3). Note that second fragmented packet 531 does not include any inner UDP header.

At 435-440 in FIG. 4, encapsulated fragmented packets may be generated and sent towards destination host-B 110B. For example in FIG. 5, encapsulation handler 119A may generate first encapsulated fragmented packet 540 (see “ENCAP1”) by encapsulating “FRAGMENT1” 530 with first outer header 541 (see “O1”). Second encapsulated fragmented packet 550 (see “ENCAP2”) may be generated by encapsulating “FRAGMENT2” 531 with second outer header 551 (see “O2”). In both cases, outer header 541/551 may be configured to specify outer source and destination IP addresses denoted as (OUTER_SIP=IP-A, OUTER_DIP=IP-B). Here, IP-A and IP-B are VTEP IP addresses associated with respective source VTEP on host-A 110A and destination VTEP on host-B 110B.

To improve receive-side processing relating to UDP fragmentation, outer header 541/551 may include the outer source PN determined at block 430. In particular, outer header 541/551 may be configured to specify OUTER_SPN=X in an outer UDP header, where X=h1(IP-VM1, IP-VM3, S1, D1). Similarly, may be configured to specify OUTER_SPN=X. This way, ENCAP1 540 and ENCAP2 550 generated from the same DATAGRAM1 510 may specify the same OUTER_SPN=X.

According to GENEVE encapsulation, outer header 541/551 may specify any suitable logical network information (e.g., VNI=5000) and outer destination PN, such as OUTER_DPN=6081. Example implementation details relating to GENEVE encapsulation may be found in a draft document entitled “Genève: Generic Network Virtualization Encapsulation” (draft-ietf-nvo3-geneve-16) published by Internet Engineering Task Force (IETF). The document is incorporated herein by reference.

(b) Receive-Side Processing

At 445-450 in FIG. 4, in response to receiving ENCAP1 540 and ENCAP2 550, destination host-B 110B may perform receive-side processing. Block 550 may include determining a hash value based on outer header 541/551. Based on the hash value, ENCAP1 540 and ENCAP2 550 may be assigned to one of multiple (M) RX queues (see 571-574 for M=4) supported by host-B 110B. See 451-452 in FIG. 4.

For example, a tuple-based approach may be implemented for queue assignment to select a particular RX queue based on outer tuple information in outer header 541/551, such as outer source IP address (“OUTER_DIP”), outer destination IP address (“OUTER_DIP”), outer source PN (“OUTER_SPN”), outer destination PN (“OUTER_DPN”). Using the tuple-based approach, encapsulated fragmented packets having the same outer tuple information may be assigned to the same RX queue.

For ENCAP1 540, host-B 110B may apply a hash function h2( ) on 4-tuple information in first outer header (01) 541 to determine a first hash value (k1) as follows: k1=h2(OUTER_SIP=IP-A, OUTER_DIP=IP-B, OUTER_SPN=X, OUTER_DPN=6081). Based on the first hash value (k1), ENCAP1 540 may be assigned or hashed to a first RX queue (see “RXQ-1” 571). See corresponding 560 in FIG. 5.

For ENCAP2 550, host-B 110B may apply the same hash function on 4-tuple information in second outer header (O2) 551 to determine a second hash value (k2) as follows: k2=h2(OUTER_SIP=IP-A, OUTER_DIP=IP-B, OUTER_SPN=X, OUTER_DPN=6081). Based on the second hash value (k2), ENCAP2 550 may also be assigned or hashed to the same queue (see “RXQ-1” 571) as ENCAP1 540. See corresponding 561 in FIG. 5.

By configuring OUTER_SPN=h1(S1) in outer header 541/551 based on the same INNER_SPN=S1 in DATAGRAM1 510, source host-A 110A may influence destination host-B 110B to assign ENCAP1 540 and ENCAP2 550 to the same RX queue 571 and/or CPU core for processing. This way, related encapsulated fragmented packets may be retrieved from the same RX queue 571 for decapsulation and reassembly (see 453) before the reassembled packet is forwarded towards destination VM3 133 (see 460). This also decreases the likelihood of out-of-order delivery for ENCAP1 540 and ENCAP2 550 and improves efficiency during reassembly.

In practice, it should be understood that large UDP datagram 510 may be divided into two or more encapsulated fragmented packets (i.e., not just ENCAP1 540 and ENCAP2 550). Similar to ENCAP2 550, any additional encapsulated fragmented packet also does not carry the inner UDP header. By configuring multiple encapsulated fragmented packets that are generated from the same UDP datagram to have the same outer tuple information, host-A 110A may influence host-B 110B to assign them to the same RX queue in a similar manner. Again, this should be contrasted against conventional approaches that do not configure outer UDP information in outer header 541/551 based on the inner UDP header.

Throughput Improvement

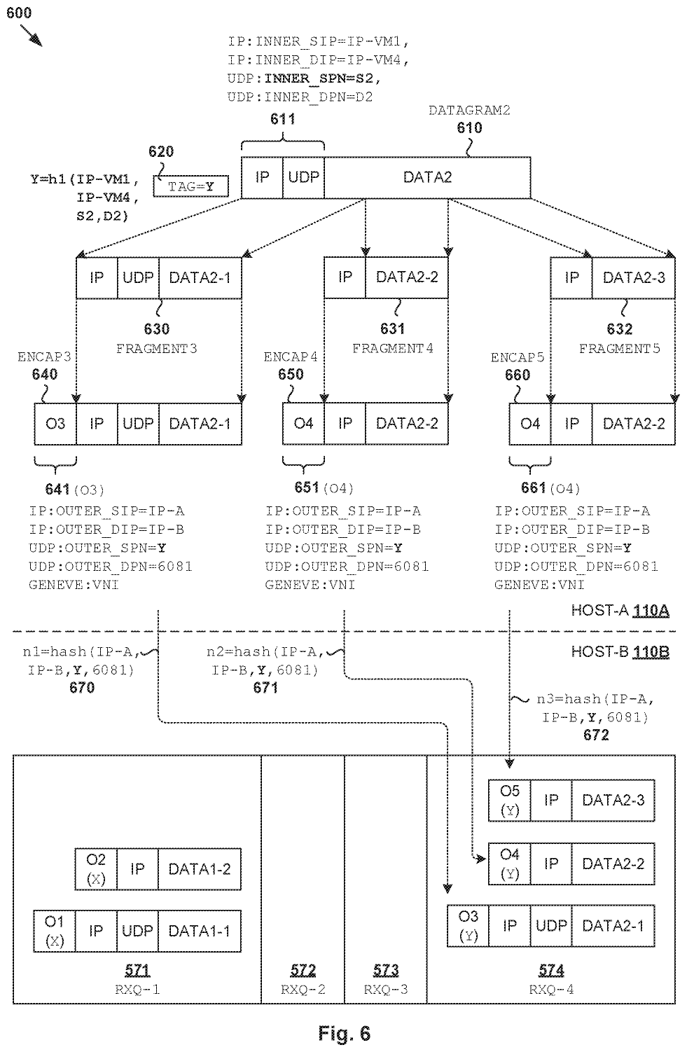

Examples of the present disclosure may be implemented to improve parallelism and throughput at host-B 110B. The example in FIG. 4 will be explained using FIG. 6, which is a schematic diagram illustrating second example 600 of encapsulated fragmented packet handling in SDN environment 100. In this example, consider another scenario where source VM1 131 wishes to send a large UDP datagram (see “DATAGRAM2” 610) to destination VM4 134 on host-B 110B. Using the example in FIG. 2, VM1 131 and VM4 144 may be deployed on the same logical layer-2 network and connected via logical switch=LS1 201.

At 620 in FIG. 6, DATAGRAM2 610 may be tagged with “TAG=Y” and sent towards encapsulation handler 119A via VNIC1 161. Referring also to 611, DATAGRAM2 610 may include an inner IP header specifying (INNER_SIP=IP-VM1, INNER_DIP=IP-VM4), an inner UDP header specifying (INNER_SPN=S2, INNER DPN=D2) and an inner payload (see “DATA2”). TAG may be generated by applying any suitable hash function h1( ) on the inner UDP tuple information, such as Y=h1(IP-VM1, IP-VM4, S2, D2).

At 630-632, fragmentation may be performed to generate multiple fragmented packets denoted as “FRAGMENT3” 630, “FRAGMENT4” 631 and “FRAGMENTS” 632. Similar to the example in FIG. 5, the inner UDP header in original DATAGRAM2 610 is included in “FRAGMENT3” 630, but excluded from “FRAGMENT4” 631 and “FRAGMENTS” 632 according to UDP specifications.

At 640-660 in FIG. 6, encapsulation may be performed to generate multiple encapsulated fragmented packets denoted as ENCAP3 640, ENCAP4 650 and ENCAP5 660. To improve receive-side processing at host-B 110B, host-A 110A may configure outer header 641/651/661 to specify the same hash value (Y), i.e., OUTER_SPN=Y based on TAG 620.

At 670-672 in FIG. 6, ENCAP3 640, ENCAP4 650 and ENCAP5 660 may be sent (in that order) towards host-B 110B for receive-side processing. Based on Y=h1(IP-VM1, IP-VM4, S2, D2), ENCAP3 640, ENCAP4 650 and ENCAP5 660 may be assigned to the same RX queue (see “RXQ-4” 574). This may involve calculating hash values n1 for ENCAP3 640, n2 for ENCAP4 650 and n3 for ENCAP5 660. Based on the same outer tuple information, n1=h2(OUTER_SIP=IP-A, OUTER_DIP=IP-B, OUTER SPN=Y, OUTER DPN=6081) and n1=n2=n3.

Using examples of the present disclosure, a first set of encapsulated fragmented packets 540-550 in FIG. 5 may be assigned to one RX queue (see “RXQ-1” 571) and a second set of encapsulated fragmented packets 640-670 in FIG. 6 to a different RX queue (see “RXQ-4” 574). This way, fragments from the same large UDP datagram may be hashed or injected in the same RX queue to avoid (or at least reduce the likelihood of) receive-side scaling (RSS) causing out-of-order delivery. The two sets may be processed in parallel, thereby improving parallelism and efficiency at host-B 110B. Examples of the present disclosure should be contrasted against conventional approaches that rely on two-tuple information for UDP packets, such as based on (OUTER_DIP=IP-A, OUTER_DIP=IP-B). In this case, all encapsulated fragmented packets from host-A 110A and host-B 110B might be hashed to the same RX queue, regardless of whether they are related or otherwise.

North-South Packet Handling

Examples of the present disclosure may be implemented for north-south packet handling where a source and a destination located at different geographical sites. An example will be described using FIG. 7, which is a schematic diagram illustrating third example 700 of encapsulated fragmented packet handling in SDN environment 100. Similar to the example in FIG. 5, consider a scenario where source=VM1 131 on host-A 110A wishes to send a large amount of data to destination=VM5 135 on host-C 110C. However, unlike FIG. 5, host-A 110A is located at a first site (see 701) and host-C 110C at a second site (see 702).

To facilitate cross-site traffic over physical network 703, EDGE1 710 (also shown in FIG. 2) may be deployed at the edge of first site 701 to communicate with EDGE2 720 at the edge of second site 702. In practice, EDGE 710/720 may be implemented using VM(s) and/or physical bare metal machine(s) and capable of performing functionalities of a switch, router, bridge, gateway, edge appliance, any combination thereof, etc. EDGE1 710 and EDGE2 720 may communicate using a pair of remote tunnel endpoint (RTEPs), such as RTEP1 711 and RTEP1 721. In practice, fragmentation is required when an MTU limit (e.g., 1500) configured for RTEP 711/721 is exceeded.

(a) Source Host-A 110A

In the example in FIG. 7, source VM1 131 may generate and send a large UDP datagram (see “DATAGRAM3” 730) towards destination VM5 135. Similar to the example in FIG. 5, DATAGRAM3 730 may include (INNER_SIP=IP-VM1, INNER_DIP=IP-VM5, INNER_SPN=S3, INNER_DPN=D3) and tagged with TAG=X=h1(IP-VM1, IP-VM5, S3, D3). According to the example in FIG. 4, host-A 110A (e.g., encapsulation handler 119A) may perform fragmentation and encapsulation to generate ENCAP1 740 and ENCAP2 741. Since ENCAP1 740 and ENCAP2 741 each include a fragment of DATAGRAM3 730, they are configured to have the same outer tuple information that includes OUTER SPN=X in respective outer headers (see “O1” and “O2”).

(b) Edge Node Processing

At EDGE1 710, ENCAP1 740 and ENCAP2 741 may be assigned to the same RX queue (see 712) for receive-side processing based on OUTER_SPN=X. Depending on the desired implementation, EDGE1 710 may perform (a) decapsulation to remove the outer header and (b) reassembly to obtain unfragmented UDP datagram 730. This way, EDGE1 710 may process the original DATAGRAM3 730 to perform any suitable networking service(s).

Next, fragmentation and encapsulation are performed to generate and send ENCAP3 750 and ENCAP4 751 towards EDGE2 720. Since ENCAP3 750 and ENCAP4 751 each include a fragment of UDP datagram 730, they are configured to have the same outer tuple information that includes (OUTER_SIP=IP-EDGE1, OUTER_DIP=IP-EDGE2, OUTER_SPN=Y, OUTER_DPN). Here, IP-EDGE1=source RTEP IP address associated with EDGE1 710 and IP-EDGE2=destination RTEP IP address associated with EDGE2 720. OUTER_SPN=Y may be configured based on the inner tuple information, such as Y=h2(IP-VM1, IP-VMS, S3, D3).

Depending on the desired implementation, OUTER_SPN=Z may be the same as, or configured based on, hash value=X in ENCAP1 740 and ENCAP2 741 received from host-A 110A. Alternatively, a different hash function h3( ) may be applied to generate a different hash value may be used, such as Z=h3(IP-VM1, IP-VMS, S3, D3). In practice, it is not necessary for X=Y, provided that ENCAP3 750 and ENCAP4 751 both include the same OUTER_SPN.

At EDGE2 720, ENCAP3 750 and ENCAP4 751 may be assigned to the same RX queue (see 722) for receive-side processing based on OUTER_SPN=Y. Similarly, EDGE2 720 may perform any suitable receive-side processing before generating and sending ENCAPS 760 and ENCAP6 761 towards host-C 110C. Since ENCAPS 760 and ENCAP6 761 each include a fragment of DATAGRAM3 730, they are configured to have the same outer tuple information that includes OUTER_SPN=Z. Again, it is not necessary for Z=X or Z=Y, provided the same OUTER_SPN is used for fragments of the same UDP datagram.

(c) Destination Host Processing

At host-C 110C, ENCAP5 760 and ENCAP6 761 may be assigned to the same RX queue (see 770) for receive-side processing based on OUTER_SPN=Z. Similarly, EDGE2 720 may perform any suitable receive-side processing, including decapsulation and reassembly. The resulting unfragmented UDP datagram 780/730 may then be delivered towards destination VM5 135.

Depending on the desired implementation, the MTU limit at host-A 110A may be different from that at EDGE1 710 and/or EDGE2 720. As such, the size of encapsulated fragmented packets 740-741, 750-751 and 760-761 may vary from one transport node to another. As mentioned above, OUTER_SPN=X may be the same or (more likely) different from Y and Z, depending on the hash algorithm used at each transport node (i.e., host-A 110A, EDGE1 710 and EDGE2 720). Using the same OUTER_SPN, the likelihood of assigning or hashing multiple encapsulated fragmented UDP packets generated from the same (unfragmented) large UDP packet to different RX queues may be reduced.

Container Implementation

Although explained using VMs, it should be understood that public cloud environment 100 may include other virtual workloads, such as containers, etc. As used herein, the term “container” (also known as “container instance”) is used generally to describe an application that is encapsulated with all its dependencies (e.g., binaries, libraries, etc.). In the examples in FIG. 1 to FIG. 7, container technologies may be used to run various containers inside respective VMs 131-134. Containers are “OS-less”, meaning that they do not include any OS that could weigh lOs of Gigabytes (GB). This makes containers more lightweight, portable, efficient and suitable for delivery into an isolated OS environment. Running containers inside a VM (known as “containers-on-virtual-machine” approach) not only leverages the benefits of container technologies but also that of virtualization technologies. The containers may be executed as isolated processes inside respective VMs.

Computer System

The above examples can be implemented by hardware (including hardware logic circuitry), software or firmware or a combination thereof. The above examples may be implemented by any suitable computing device, computer system, etc. The computer system may include processor(s), memory unit(s) and physical NIC(s) that may communicate with each other via a communication bus, etc. The computer system may include a non-transitory computer-readable medium having stored thereon instructions or program code that, when executed by the processor, cause the processor to perform process(es) described herein with reference to FIG. 1 to FIG. 7.

The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), and others. The term ‘processor’ is to be interpreted broadly to include a processing unit, ASIC, logic unit, or programmable gate array etc.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or any combination thereof.

Those skilled in the art will recognize that some aspects of the embodiments disclosed herein, in whole or in part, can be equivalently implemented in integrated circuits, as one or more computer programs running on one or more computers (e.g., as one or more programs running on one or more computing systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

Software and/or to implement the techniques introduced here may be stored on a non-transitory computer-readable storage medium and may be executed by one or more general-purpose or special-purpose programmable microprocessors. A “computer-readable storage medium”, as the term is used herein, includes any mechanism that provides (i.e., stores and/or transmits) information in a form accessible by a machine (e.g., a computer, network device, personal digital assistant (PDA), mobile device, manufacturing tool, any device with a set of one or more processors, etc.). A computer-readable storage medium may include recordable/non recordable media (e.g., read-only memory (ROM), random access memory (RAM), magnetic disk or optical storage media, flash memory devices, etc.).

The drawings are only illustrations of an example, wherein the units or procedure shown in the drawings are not necessarily essential for implementing the present disclosure. Those skilled in the art will understand that the units in the device in the examples can be arranged in the device in the examples as described or can be alternatively located in one or more devices different from that in the examples. The units in the examples described can be combined into one module or further divided into a plurality of sub-units.

We claim:

1. A method for a first computer system to perform encapsulated fragmented packet handling, wherein the method comprises:
detecting an egress packet that requires fragmentation, wherein the egress packet includes an inner payload and an inner transport layer header that is generated according to a connectionless transport layer protocol;
determining an outer connectionless transport layer value based on content of the inner transport layer header;
generating a first encapsulated fragmented packet that includes a first fragment of the inner payload, the inner transport layer header and a first outer header specifying the outer connectionless transport layer value;
generating a second encapsulated fragmented packet that includes a second fragment of the inner payload and a second outer header specifying the outer connectionless transport layer value; and
forwarding the first encapsulated fragmented packet and the second encapsulated fragmented packet towards a second computer system to cause receive-side processing based on the outer connectionless transport layer value in both the first outer header and the second outer header.

2. The method of claim 1, wherein determining the outer connectionless transport layer value comprises:
identifying an inner user datagram protocol (UDP) source port number specified by an inner UDP header, being the inner transport layer header; and
determining the outer connectionless transport layer value, being an outer UDP source port number, based on the inner UDP source port number.

3. The method of claim 2, wherein determining the outer connectionless transport layer value comprises:
determining the outer UDP source port number by applying a hash algorithm on an inner source Internet Protocol (IP) address, an inner destination IP address, the inner UDP source port number and an inner UDP destination port number.

4. The method of claim 2, wherein determining the outer connectionless transport layer value comprises:
identifying the outer UDP source port number based on tag information generated by a virtualized computing instance from which the egress packet originates.

5. The method of claim 2, wherein generating the first encapsulated fragmented packet and the second encapsulated fragmented packet comprises:
configuring the first outer header and the second outer header to specify the same outer UDP source port number to cause the second computer system to assign both the first encapsulated fragmented packet and the second encapsulated fragmented packet into a same receive (RX) queue.

6. The method of claim 1, wherein detecting the egress packet comprises:
detecting, by the first computer system in the form of a first host, the egress packet from a virtualized computing instance via a virtual network interface controller (VNIC) that is capable of fragmentation offload.

7. The method of claim 1, wherein detecting the egress packet comprises:
detecting, by the first computer system in the form of a first edge, the egress packet that originates from a virtualized computing instance supported by a first host, wherein the first edge is capable of performing reassembly to regenerate the egress packet.

8. A non-transitory computer-readable storage medium that includes a set of instructions which, in response to execution by a processor of a computer system, cause the processor to perform a method of encapsulated fragmented packet handling, wherein the method comprises:
detecting an egress packet that requires fragmentation, wherein the egress packet includes an inner payload and an inner transport layer header that is generated according to a connectionless transport layer protocol;
determining an outer connectionless transport layer value based on content of the inner transport layer header;
generating a first encapsulated fragmented packet that includes a first fragment of the inner payload, the inner transport layer header and a first outer header specifying the outer connectionless transport layer value;
generating a second encapsulated fragmented packet that includes a second fragment of the inner payload and a second outer header specifying the outer connectionless transport layer value; and
forwarding the first encapsulated fragmented packet and the second encapsulated fragmented packet towards a second computer system to cause receive-side processing based on the outer connectionless transport layer value in both the first outer header and the second outer header.

9. The non-transitory computer-readable storage medium of claim 8, wherein determining the outer connectionless transport layer value comprises:
identifying an inner user datagram protocol (UDP) source port number specified by an inner UDP header, being the inner transport layer header; and
determining the outer connectionless transport layer value, being an outer UDP source port number, based on the inner UDP source port number.

10. The non-transitory computer-readable storage medium of claim 9, wherein determining the outer connectionless transport layer value comprises:
determining the outer UDP source port number by applying a hash algorithm on an inner source Internet Protocol (IP) address, an inner destination IP address, the inner UDP source port number and an inner UDP destination port number.

11. The non-transitory computer-readable storage medium of claim 9, wherein determining the outer connectionless transport layer value comprises:
identifying the outer UDP source port number based on tag information generated by a virtualized computing instance from which the egress packet originates.

12. The non-transitory computer-readable storage medium of claim 9, wherein generating the first encapsulated fragmented packet and the second encapsulated fragmented packet comprises:
configuring the first outer header and the second outer header to specify the same outer UDP source port number to cause the second computer system to assign both the first encapsulated fragmented packet and the second encapsulated fragmented packet into a same receive (RX) queue.

13. The non-transitory computer-readable storage medium of claim 8, wherein detecting the egress packet comprises:
detecting, by the first computer system in the form of a first host, the egress packet from a virtualized computing instance via a virtual network interface controller (VNIC) that is capable of fragmentation offload.

14. The non-transitory computer-readable storage medium of claim 8, wherein detecting the egress packet comprises:
detecting, by the first computer system in the form of a first edge, the egress packet from a first host that supports a virtualized computing instance from which the egress packet originates.

15. A computer system, being a first computer system, comprising:
a processor; and
a non-transitory computer-readable medium having stored thereon instructions that, when executed by the processor, cause the processor to:
detect an egress packet that requires fragmentation, wherein the egress packet includes an inner payload and an inner transport layer header that is generated according to a connectionless transport layer protocol;
determine an outer connectionless transport layer value based on content of the inner transport layer header;
generate a first encapsulated fragmented packet that includes a first fragment of the inner payload, the inner transport layer header and a first outer header specifying the outer connectionless transport layer value;
generate a second encapsulated fragmented packet that includes a second fragment of the inner payload and a second outer header specifying the outer connectionless transport layer value; and
forward the first encapsulated fragmented packet and the second encapsulated fragmented packet towards a second computer system to cause receive-side processing based on the outer connectionless transport layer value in both the first outer header and the second outer header.

16. The computer system of claim 15, wherein the instructions for determining the outer connectionless transport layer value cause the processor to:
identify an inner user datagram protocol (UDP) source port number specified by an inner UDP header, being the inner transport layer header; and
determine the outer connectionless transport layer value, being an outer UDP source port number, based on the inner UDP source port number.

17. The computer system of claim 16, wherein the instructions for determining the outer connectionless transport layer value cause the processor to:
determine the outer UDP source port number by applying a hash algorithm on an inner source Internet Protocol (IP) address, an inner destination IP address, the inner UDP source port number and an inner UDP destination port number.

18. The computer system of claim 16, wherein the instructions for determining the outer connectionless transport layer value cause the processor to:
identify the outer UDP source port number based on tag information generated by a virtualized computing instance from which the egress packet originates.

19. The computer system of claim 16, wherein the instructions for generating the first encapsulated fragmented packet and the second encapsulated fragmented packet cause the processor to:
configure the first outer header and the second outer header to specify the same outer UDP source port number to cause the second computer system to assign both the first encapsulated fragmented packet and the second encapsulated fragmented packet into a same receive (RX) queue.

20. The computer system of claim 15, wherein the instructions for detecting the egress packet cause the processor to:
detect, by the first computer system in the form of a first host, the egress packet from a virtualized computing instance via a virtual network interface controller (VNIC) that is capable of fragmentation offload.

21. The computer system of claim 15, wherein the instructions for detecting the egress packet cause the processor to:
detect, by the first computer system in the form of a first edge, the egress packet from a first host that supports a virtualized computing instance from which the egress packet originates.
